(19) United States
(12) Patent Application Publication
(10) Pub. No.: US 2015/0021961 A1
(43) Pub. Date: Jan. 22, 2015

(54) HOLDER FOR AN OPERATING CONSOLE IN AN AIRCRAFT SEAT

(71) Applicant: LUFTHANSA TECHNIK AG, HAMBURG (DE)

(72) Inventors: Jan Remmer Ter Haseborg, Buchholz (DE); Viktor Daubner, Hamburg (DE)

(21) Appl. No.: 14/382,216

(22) PCT Filed: Mar. 20, 2013
(86) PCT No.: PCT/EP2013/000841

§ 371 Date: Aug. 29, 2014

(30) Foreign Application Priority Data
Mar. 23, 2012 (DE) 10 2012 204 736.0

(51) Int. Cl. B64D 11/00; B64D 11/06

(52) U.S. Cl. CPC B64D 11/0015; B64D 11/06; B64D 2011/0662
USPC 297/188.04

(57) ABSTRACT

The invention relates to a holder for a control console or a display device on an aircraft seat, the holder being arranged in an armrest, backrest or the trim of the aircraft seat. The control console is removable from the holder. The holder comprises a support arm, by means of which the control console or display device can be supported, and the control console or display device which is supported on the support arm can be fixed in the holder in a secured position. The control console or display device which is supported on the support arm can be moved out of the secured position into a display position, and the control console or display device can only be removed from the support arm in the display position. The control console or display device can be pivoted about at least one pivot axis in the display position.

The invention relates to a holder for a control console or a display device on an aircraft seat having the features of the preamble of claim 1.

Control consoles are used for example to operate entertainment units, to control the movement of adjustable units of the aircraft seat or also to communicate with the cabin crew. In accordance with the solutions known from the prior art, the control consoles are held in a receptacle in the armrest, the backrest or other parts of the trim of the aircraft seat and can, if necessary, be removed from the receptacle for mobile operation.

The control console can be fixed in a secured position in order to hold said control console securely in certain flight situations, such as take-off or landing, and also if necessary in the event of a crash, to prevent passengers from being injured by a control console which is loose in the cabin of the aircraft. In the secured position, the control console is arranged in a casing as a form of holder, which surrounds the control console and only leaves one side of the control console visible. Owing to the control console being laterally clasped by the casing, in the secured position it is secured against inadvertently slipping out.

So that the control console can be operated in an ergonomically accessible manner in the receptacle, the receptacle has to be arranged in a position which is accessible for the operator, since the control console can no longer be adjusted once it is in the receptacle. Since the aircraft seat is in principle generally used by occupants of different body sizes and body proportions and the position of the aircraft seat can generally be altered, owing to the arrangement of the receptacle, the operation of the control console can only ever be optimal for a few body sizes and seat positions. The control console receptacle is normally arranged flat on an armrest of the aircraft seat.

In this context, the problem addressed by the invention is that of providing a holder for a control console in an aircraft seat which makes possible the improved operability of the control console for different operators and seat positions.

The problem is solved according to the invention by a holder having the features of claim 1. Further preferred developments can be found in the dependent claims, the description and the accompanying drawings.

According to claim 1, in order to solve the problem, a holder for a control console or a display device on an aircraft seat is proposed, the holder being arranged in an armrest, backrest or the trim of the aircraft seat, and it being possible for the control console to be removed from the holder. In the following description of the invention, this is representatively described with reference to a control console, it being possible for said console also to be considered in principle to represent purely a display device. According to the invention, the holder comprises a support arm, by means of which the control console can be supported. Furthermore, the control console which is supported on the support arm can be fixed in the holder in a secured position and can be moved out of the secured position into a display position. The control console can only be removed from the support arm in the display position, and the control console can be pivoted about at least one pivot axis in the display position.

The control console or display device can be deployed and oriented out of the secured position into a display position by means of the support arm. The orientation of the control console in a display position by pivoting is advantageous for improved operability because in this way it is possible for the operator to view the control console in any seat position, and thus the operability and accessibility of said control console is improved without the operator having to remove the control console. It is therefore not necessary, for example in a reclined position of the seat, for the control console to be held in the hands or to rest on the seat or the operator's body. This is advantageous in terms of operability in particular for the use of control consoles having touch-sensitive screens. The passenger or operator can pivot and orient the control console or display device so that, irrespective of his body size and seat position, he has a largely perpendicular view of the control surface of the control console, in particular of a possible touch-sensitive screen of the control console, or of the display device which may be a screen, without said console or device having to be removed from the support arm and from the armrest, backrest or the trim of the aircraft seat. A view that is as perpendicular as possible is advantageous in particular to make screens easy to read. The operator still has the option of removing the control console or display device and accordingly operating and viewing it, in order to, for example, make it possible for said console or device to be continuously held for controlling games.

In advantageous embodiments, the control console or display device may be permanently connected to the holder. Said permanent connection may be produced for example by means of a cable- and/or cord connection between the control console or display device and the holder. Owing to the cord connection, the control console or display device can be removable from the holder and can be used at a certain distance therefrom, while at the same time the permanent connection can be maintained. The problem addressed by the invention can thus also be solved by a holder comprising a control console or display device on an aircraft seat.

It is further proposed that the support arm comprises a plurality of fingers which clasp the sides of the control console. A type of frame is produced on the support arm by the fingers, in which frame the control console is secured against slipping out on at least three sides. In this case, the fingers can be arranged so that a slot which is open on one side is formed, into which slot the control console can be slid and from which said console can be removed in one direction. Preferably, the control console can be removed from the holder in this direction.

The control console being secured against slipping out of the support arm can make it possible for the control console to be freely arranged in a plurality of directions when in the secured position. A casing for securing the control console in the secured position can therefore be omitted, thereby making it possible to give the holder and in particular the control console a relatively delicate appearance in addition to reducing the weight of said holder. Various embodiments having various cut-outs or control consoles which only face the holder on one side when in the holder are possible. In the secured position of the holder, the control console may therefore give the impression that the control console is floating above the armrest, for example.

Furthermore, it is proposed that the control console comprises at least one finger receptacle, into which the support arm can be inserted with at least one finger. The control console may be alternatively or additionally supported on the support arm by the finger inserted into the finger receptacle.

Advantageously, the control console is supported on the support arm by at least one magnet arranged in the control console and/or in the support arm. The magnet can hold the control console in the secured position and/or in the display position on the support arm, and, in the display position, said console can be released by the passenger or operator by overcoming the magnetic force between the magnet and the corresponding counterpart. In this way, the support arm can be fixed or removed without movable parts, such as spring clips, this being advantageous for the durability of the holder. Combining this with a mechanical guide through the support arm is advantageous.

Particularly easy pivoting of the control console can also be produced by the support arm being supported on the receptacle by means of a ball joint and/or the control console being supported on the support arm by means of a ball joint. In this case, the ball joint or joints not only make it possible to pivot the control console about mutually orthogonally oriented pivot axes, but also to pivot said console about any intermediate axes, the possible use of two ball joints producing additional degrees of freedom for adjustability. Furthermore, ball joints are in principle a very easy to produce and structurally robust type of pivotable bearing for the support arm or the control console, which can for example be mounted using a simple clipping process.

In an advantageous embodiment, the ball joint is configured to release the support arm when a defined load is exceeded. This may be advantageous in terms of safety in order to prevent passengers from being injured if they knock into the support arm and/or the control console. Furthermore, the holder can be prevented from being damaged by being knocked into and/or by forces resulting from misuse being applied. Preferably, the ball of the ball joint is released upwards. The defined load is structurally set from the point of view of preventing injury.

Alternatively, the pivotability of the control console can also be produced by the support arm being suspended by cardan joints in the receptacle or by the control console being suspended by cardan joints on the support arm.

Preferably, the pivot axes of the support arm can be fixed in the secured position by at least one blocking element. In the secured position, the control console is secured against falling or slipping out. In addition, it is advantageous if the control console does not rotate about a pivot axis in this secured position, so that for example in the event of a crash, no edges can point towards the operator, in order to prevent injuries. The blocking element or the blocking elements can, in addition to fixing the pivoting movement, prevent the control console from being removed in the secured position. The blocking element can preferably be released manually by the operator.

In an advantageous embodiment, the holder comprises a securing pin, said securing pin engaging in the control console at least in the secured position. As a result of this, the control console can be advantageously blocked against movement out of the support arm in the removal direction in the secured position. Here, the embodiment having a securing pin leads in a simple manner to it being possible to remove the control console once the support arm comprising the control console is moved out of the secured position.

Preferably, the holder comprises a spring, which orients the control console into a predetermined position after it has been released from the secured position. This is useful in particular if the secured position has been released by an operator, so that the spring actively moves the control console out of the secured position. The predetermined position is a possible display position which is advantageously perceived by the user to differ visually from the secured position and makes it possible to easily grip and orient the control console on the support arm.

Furthermore, it is proposed that the holder comprises a receptacle which fixes the control console in the holder in the secured position. The receptacle is formed by a recess which is geometrically adapted to the outer shape of the control console. The receptacle in the form of the geometrically adapted recess and the proposed arrangement of the pivot axis makes it possible to entirely embed the control console in a surface of the aircraft seat, with the depth of the recess being accordingly dimensioned and there being a simultaneously easy-to-manipulate release movement of the control console out of the recess by pivoting the control console out of the recess.

Preferably, a buffer having resilient flexibility is arranged between the holder and the support arm. The resilient flexibility is preferably of a magnitude such that during normal manipulation, the support arm only has low resilient deformation, but yields when forces resulting from misuse are applied, for example to protect the operator and/or the mechanical structure of the holder.

In an advantageous embodiment, the control console is arranged on the support arm so as not to rotate about an axis, the axis being orthogonal to the pivot axis. As a result, the control apparatus is prevented from tilting to the side, this being advantageous in particular for screen-based control consoles or display devices in order to prevent an undesired angled view.

The invention is explained in the following on the basis of preferred embodiments with reference to the accompanying drawings, in which:

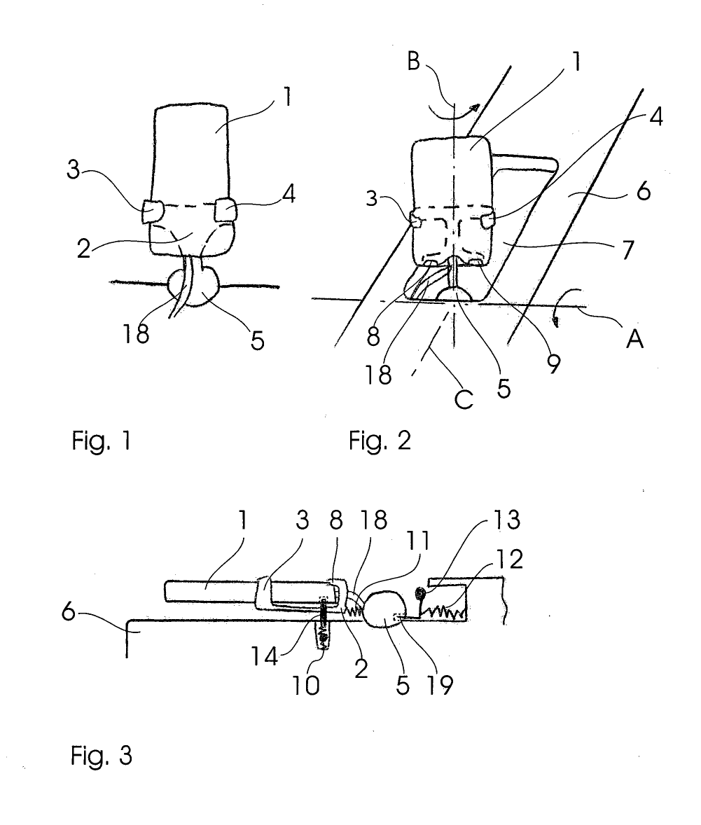

FIG. 1 shows a control console with a support arm;

FIG. 2 shows a control console in the display position;

FIG. 3 shows a control console in the secured position;

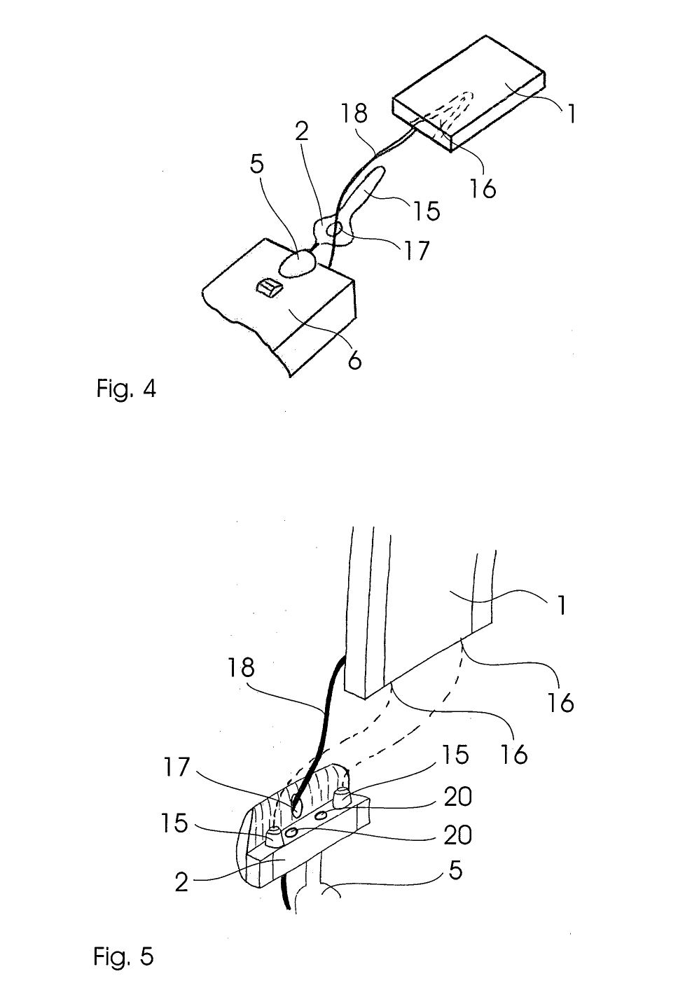

FIG. 4 shows a control console in a position in which it is released from a support arm; and

FIG. 5 shows a further control console in a position in which it is released from a support arm.

The following embodiments are based on a control console which comprises a user interface for operation and additionally comprises display elements, such as screens, or combined display- and input elements, such as touch-sensitive screens. The embodiments are also possible for purely display devices in a similar manner.

FIG. 1 shows a control console 1 which is supported on a support arm 2 which laterally clasps the outer edge of the control console 1 with two fingers 3 and 4. The end of the support arm 2 comprises a ball joint 5, by means of which it is pivotally mounted, as described further in the following. In this embodiment, the support arm 2 is formed by a triangular base plate having two lateral fingers 3 and 4 which form a slot which is open towards the top and into which the control console 1 can be slid from the top.

The control console 1 is connected to the holder by an electrical cable 18 for the further transmission of control signals, it being possible for the holder to preferably have a cavity in which an excess quantity of an electrical cable 18 of the control console 1 can be received. As a result, the cabling and the arrangement of the wiring can generally be simplified to the extent that the wiring does not hinder the movement of the control console 1 and in particular the removal of said console from the support arm 2 and the replacement of said console on said support arm.

FIG. 2 shows a slightly further developed embodiment of the invention, in which the support arm 2 is formed by an X-shaped base plate having four fingers 3, 4, 8 and 9 which laterally clasp the control console 1. The end of the support arm 2 is also provided with a ball joint 5, by means of which it is pivotally mounted in an edge portion of a receptacle 7. The receptacle 7 has a geometry which is adapted to the rectangular outer shape of the control console 1 and is arranged in an armrest 6 of an aircraft seat. The receptacle 7 is formed by a recess and the depth thereof is dimensioned such that the control console 1 can be received entirely therein in the secured position.

In the position shown, the control console 1 is in a display position, in which the control console 1 is moved out of the receptacle 7 and is thereby closer to and facing the operator. Furthermore, the control console 1 can be pivoted in the direction of the arrow about a pivot axis A which is parallel to an edge of the receptacle 7 by being mounted in the ball joint 5, thereby also making the movement out of the secured position possible in this embodiment, so that the operator can pivot the control console 1 closer to or further away from him, as required. Furthermore, the control console 1 can be pivoted or rotated about a second pivot axis B and/or C, which is orthogonal to the pivot axis A, by rotating the support arm 2 in the ball joint 5, whereby the control console 1 can be pivoted for example for the purposes of better readability or better accessibility.

In a possible embodiment, it is not possible to pivot the control console 1 about the axis C on the support arm 2, so that the control console 1 is prevented from tilting to the side.

FIG. 3 shows an alternative embodiment of the control console 1 in a secured position. In this embodiment, the control console 1 is not laterally surrounded by a receptacle 7, but is freely positioned on an armrest. A securing pin 14 secures the control console 1 against being removed from or slipping out of the support arm 2 in the secured position.

The secured position is preferably secured and fixed by a blocking element 19. In this embodiment, the blocking element 19 engages in the ball joint 5 in the secured position and blocks pivoting of the support arm 2. The secured position can be released by manually actuating the actuation element 13. The actuation element 13 is displaced against the spring force from the spring 12 in order to unlock the control console 1. The blocking element 19 is consequently moved out of engagement with the ball joint 5, thereby enabling the movement of the support arm 2.

In this embodiment, in the secured position the securing pin 14 presses against the control element 1 in a spring-loaded manner by means of a spring 10, so that the support arm 2 together with the control element 1 is pushed upwards into a predetermined position or a starting position once the secured position has been released, so that the blocking element 19 can no longer engage in the ball joint 5 in this position of the support arm 2. Therefore, in this embodiment, a single actuation of the actuation element 13 leads to the control console 1 moving out of the secured position into a starting position or a display position. The spring 10 can, as shown in FIG. 3, be combined with the securing pin 14. The predetermined position may be part of the display position, in which the control console 1 together with the support arm 2 can be more easily gripped and manually moved. In a possible embodiment, the starting position may differ from the display position, it still not being possible to remove the control console 1 from the holder in the starting position, and the control console 1 firstly having to be manually moved into a display position.

In the embodiment from FIG. 2, the control console 1 which has been moved into the predetermined position projects at least slightly beyond the edge of the receptacle 7, and as a result can be gripped by the operator or passenger.

The operator can grip the control console 1 in the starting position and can orient it by pivoting as desired. Optionally, the operator can remove the control console 1 from the support arm 2 and can freely position the control console 1 in the region of his seat.

Furthermore, the operator can then put the control console 1 back on the support arm 2. In order to fix it in the secured position, the operator presses the control console 1 into the secured position against the force of the spring 10. In the secured position, the preferably spring-loaded blocking element 19 engages in the ball joint 5. In this position, the securing pin 14 engages in an indentation in the control console. The control console 1 is held in the secured position by the blocking element 19 and the securing pin 14.

A buffer 11 is also provided between the ball joint 5 and the support arm 2, and substantially does not influence the movement behaviour in normal conditions, but is intended to enable the control console 1 or support arm 2 to yield if large forces are acting thereon, so that the operator or another passenger is less likely to be injured or the holder is less likely to sustain mechanical damage. The buffer 11 may for example be formed as a steel spring.

After the control console 1 is unlocked, it can be manually moved into the display position shown in FIG. 2, in which it can be further oriented owing to the pivotability which is provided, it also being possible for the control console 1 to be pivoted about the pivot axes A, B and/or C before the display position is reached. The pivoting movement advantageously involves friction, so that the display position is maintained until further manual manipulation takes place. The corresponding frictional resistance may, for example in the embodiment in FIG. 3, be preset by the fit in the ball joint. Furthermore, during the pivoting movements, the frictional resistance can be obtained and/or adjusted by the spring 12 which presses the blocking element 19 onto the ball of the ball joint 5 in the display position.

FIG. 4 shows a further preferred embodiment, a control console 1 being shown in a position in which it is released from a support arm 2. The control console 1 comprises a finger receptacle 16 and the support arm 2 comprises a finger 15 which is adapted to the shape of the finger receptacle 16, which finger is inserted into the finger receptacle 16 to support the control console 1 and is releasably attached for example by a catch. In this case, the finger 15 replaces the fingers 3, 4, 8 and 9 in the embodiment shown in FIGS. 1 to 3, so that in an embodiment having a receptacle 7, the control console 1 can be arranged in a geometrically adapted receptacle 7 with a relatively small outer gap. Furthermore, the control console 1 can consequently also be folded onto a corresponding cut-out in the outer contour of the armrest or backrest with an aesthetically pleasing appearance, it not being possible to see the support arm 2 from the outside. Furthermore, a guide 17 in the form of an opening in the support arm 2 is provided on the support arm 2, through which opening the electrical cable 18 of the control console 1 is guided.

FIG. 5 shows an alternative embodiment, two fingers 15 being arranged on the support arm 2 which fingers can be inserted into two finger receptacles 16 of the control element 1. In this embodiment, the fingers 15 are designed as conical guide pins having a beveled edge. In the attached position, the control console 1 is supported by two magnets 20, which releasably support the control console 1 on the support arm 2. A corresponding counterpart to the magnets is arranged in the control console 1, it being possible for the counterpart to be a magnet of opposite polarity or a ferromagnetic element.

1. A holder for a control console or a display device on an aircraft seat,
the holder being arranged in an armrest, backrest or the trim of the aircraft seat,
the control console or display device being removable from the holder, wherein
the holder comprises a support arm, by means of which the control console or display device can be supported, and
the control console or display device which is supported on the support arm can be fixed in the holder in a secured position, and
the control console or display device which is supported on the support arm can be moved out of the secured position into a display position, and
the control console or display device can only be removed from the support arm in the display position, and
the control console or display device can be pivoted about at least one pivot axis (A) in the display position.

2. The holder according to claim 1, wherein the support arm is supported on the holder by means of a ball joint and/or the control console or display device is supported on the support arm by means of a ball joint.

3. The holder according to claim 2, wherein the ball joint is designed to release the support arm when a defined load is exceeded.

4. The holder according to claim 1, wherein the support arm is suspended by cardan joints in the receptacle or the control console or display device is suspended by cardan joints on the support arm.

5. The holder according to claim 1, wherein the pivot axes (A, B, C) of the support arm can be fixed in the secured position by at least one blocking element.

6. The holder according to claim 1, wherein the support arm comprises a plurality of fingers which clasp the sides of the control console or display device.

7. The holder according to claim 1, wherein the control console or display device comprises at least one finger receptacle, into which the support arm can be inserted with at least one finger.

8. The holder according to claim 1, wherein the control console or display device is supported on the support arm by at least one magnet arranged in the control console or display device and/or in the support arm.

9. The holder according to claim 1, wherein the holder comprises a securing pin, said securing pin engaging in the control console or display device at least in the secured position.

10. The holder according claim 1, wherein the holder comprises a spring, which orients the control console or display device into a predetermined position after it has been released from the secured position.

11. The holder according to claim 1, wherein the holder comprises a receptacle which fixes the control console or display device in the holder in the secured position.

12. The holder according to claim 1, wherein a buffer having resilient flexibility is arranged between the holder and the support arm.

13. The holder according to claim 1, wherein the control console or display device is arranged on the support arm so as not to rotate about an axis (C), the axis (C) being orthogonal to the pivot axis (A).
